(19) United States
(12) Patent Application Publication
(10) Pub. No.: US 2025/0078800 A1
(43) Pub. Date: Mar. 6, 2025

(54) NON-COHERENT NOISE REDUCTION METHOD AND NON-COHERENT NOISE REDUCTION DEVICE

(71) Applicant: MEDIATEK INC., Hsin-Chu (TW)

(72) Inventors: Yun-Shao Lin, Hsinchu City (TW); Tsung-Han Lee, Hsinchu City (TW); Liang-Che Sun, Hsinchu City (TW); Yiou-Wen Cheng, Hsinchu City (TW)

(73) Assignee: MEDIATEK INC., Hsin-Chu (TW)

(21) Appl. No.: 18/818,610

(22) Filed: Aug. 29, 2024

Related U.S. Application Data
(60) Provisional application No. 63/580,399, filed on Sep. 4, 2023.

(51) Int. Cl. G10K 11/178

(52) U.S. Cl. CPC G10K 11/17823; G10K 2210/3213

(57) ABSTRACT

A non-coherent noise reduction method, comprising: (a) receiving a plurality of input audio sensing signals by a processor, wherein the input audio sensing signals correspond to a plurality of channels responsive to sensing by a plurality of audio sensors; (b) detecting whether non-coherent noise exists in at least one of the channels by a non-coherent noise detector; (c) estimating at least one noise power of the non-coherent noise by a noise power estimator, if the non-coherent noise exists in at least one of the channels; (d) deriving at least one noise contour of the non-coherent noise by a noise contour estimator, if the non-coherent noise exists in at least one of the channels; and (e) enhancing the input audio sensing signals according to the noise power and the noise contour if the non-coherent noise exists in at least one of the channels.

### CROSS REFERENCE TO RELATED APPLICATIONS

This application claims the benefit of U.S. Provisional Application No. 63/580,399, filed on Sep. 4, 2023. The content of the application is incorporated herein by reference.

### BACKGROUND

Conventionally, there are generally two types of noise, namely coherent noise and non-coherent noise, to which a multi-microphone device with two or more microphones may be exposed. Specifically, the noise that simultaneously appears on multiple microphones of a device with a similar signal pattern is considered a coherence noise. In contrast, the noise that appears on the multiple microphones of the device with different signal patterns is considered a non-coherent noise. For example, since the sound of a car engine picked up by the multiple microphones is from the same source (i.e., the engine or a car) and has a similar signal pattern on those microphones, it is a coherent noise. As another example, as the noise from local wind shear turbulence around each microphone results in different signal patterns on the multiple microphones, it is a non-coherent noise. That is, when a natural wind blows, different microphones receive wind noise at different times and intensities; and, as the noise detected or sensed by each microphone is local, the wind noises at different microphones have no causal relationship there between and thus belong to a type of non-coherent noise.

For example, two microphones are mounted on different sides of a multi-microphone device, wind noise sensed by one of the microphones may be greater and earlier than the other microphone since one of the microphones is facing the wind. However, a conventional multi-microphone device does not have a strong and robust wind noise reduction method, due to various reasons. For example, wind noise has distinct non-coherent characteristics that cannot be effectively cancelled out by conventional noise reduction methods. For another example, the suppression-based methods may result in low-quality recording after noise cancellation. Additionally, wind noise reduction methods may interfere with other signal processing components.

Therefore, there is a need for a solution of non-coherent noise reduction method for audio enhancement on a multi-microphone device.

### SUMMARY

One objective of the present application is to provide a non-coherent noise reduction method which can effectively reduce the non-coherent noise without decreasing signal qualities of the audio sensing signals.

Another objective of the present application is to provide an electronic device which can effectively reduce the non-coherent noise without decreasing signal qualities of the audio sensing signals.

One embodiment of the present application discloses a non-coherent noise reduction method, comprising: (a) receiving a plurality of input audio sensing signals by a processor, wherein the input audio sensing signals correspond to a plurality of channels responsive to sensing by a plurality of audio sensors; (b) detecting whether non-coherent noise exists in at least one of the channels by a non-coherent noise detector; (c) estimating at least one noise power of the non-coherent noise by a noise power estimator, if the non-coherent noise exists in at least one of the channels; (d) deriving at least one noise contour of the non-coherent noise by a noise contour estimator, if the non-coherent noise exists in at least one of the channels; and (e) enhancing the input audio sensing signals according to the noise power and the noise contour if the non-coherent noise exists in at least one of the channels.

Another embodiment of the present application discloses an electronic device, comprising: a plurality of audio sensors, configured to sensing a plurality of audio sensing signals; a processor, configured to perform following steps: (a) receiving a plurality of input audio sensing signals generated according to the audio sensing signals, wherein the input audio sensing signals correspond to a plurality of channels responsive to sensing by the audio sensors; (b) controlling a non-coherent noise detector to detect whether non-coherent noise exists in at least one of the channels; (c) controlling a noise power estimator to estimate at least one noise power of the non-coherent noise, if the non-coherent noise exists in at least one of the channels; (d) controlling a noise contour estimator to derive at least one noise contour of the non-coherent noise, if the non-coherent noise exists in at least one of the channels; and (e) enhancing the input audio sensing signals according to the noise power and the noise contour if the non-coherent noise exists in at least one of the channels.

In view of above-mentioned embodiments, the wind power in each bin, each channel may be estimated. Also, the signals with dynamic ranges of bin and weight are mixed such that stereo output or even multi-channel output may be provided. Further, suppression levels of the wind noise reducer may be dynamically adjusted. Additionally, the beam forming strategies without wind noise reduction and with wind noise reduction may be switched.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an electronic device with multi-microphones according to one embodiment of the present application.

FIG. 2 is a schematic diagram illustrating a non-coherent noise reduction method according to one embodiment of the present application.

FIG. 3 is a schematic diagram illustrating a HDR algorithm for the audio sensing signals generated by microphones, according to one embodiment of the present application.

FIG. 4 is a schematic diagram illustrating the normal beam forming illustrated in FIG. 2, according to one embodiment of the present application.

FIG. 5 is a schematic diagram illustrating the wind beam forming illustrated in FIG. 2, according to one embodiment of the present application.

FIG. 6 is a schematic diagram illustrating a non-coherent noise reduction method according to another embodiment of the present application.

FIG. 7 is a schematic diagram illustrating a summary of a non-coherent noise reduction method according to one embodiment of the present application.

FIG. 8 is a block diagram illustrating an exemplary electronic device applying the non-coherent noise reduction method provided by the present application.

### DETAILED DESCRIPTION

Several embodiments are provided in following descriptions to explain the concept of the present invention. The method in following descriptions can be performed by executing programs stored in a non-transitory computer readable recording medium by a processor. The non-transitory computer readable recording medium can be, for example, a hard disk, an optical disc or a memory. Additionally, the term “first”, “second”, “third” in following descriptions are only for the purpose of distinguishing different one elements, and do not mean the sequence of the elements. For example, a first device and a second device only mean these devices can have the same structure but are different devices. Further, in following embodiments, wind noise is used as an example for explaining. However, the concepts disclosed by the present application may be used to any other non-coherent noise. Additionally, microphones are used as examples for explaining in following embodiments. However, the concepts disclosed by the present application may be used to any other audio sensor.

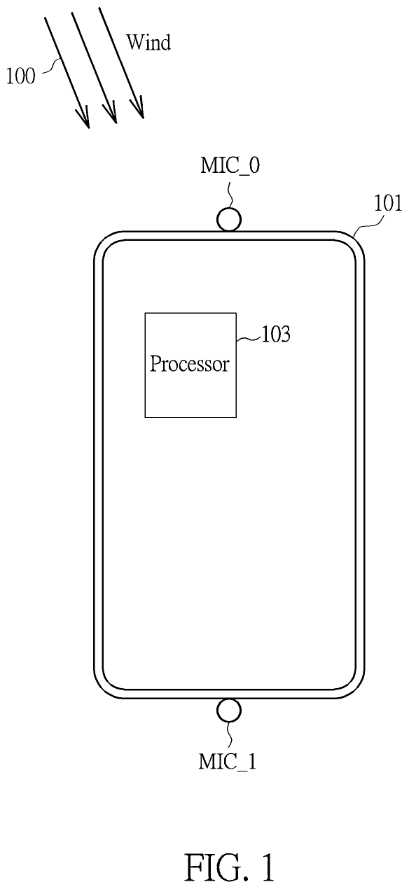

FIG. 1 is a schematic diagram illustrating an electronic device with multi-microphones according to one embodiment of the present application. As shown in FIG. 1, the exemplary environment 100 may involve an electronic device 101 being exposed or subject to various noises, including coherent noises and non-coherent noises, which the electronic device 101 may sense, detect or otherwise measure. The electronic device 101 may be a portable or mobile device with multiple audio sensors such as microphones installed thereon, with each of the audio sensors mounted or otherwise disposed on a respective location on the electronic device 101 to sense noises and sounds in the surrounding of the electronic device 101. The electronic device 101 may be equipped with a processor 103 that is configured to implement various schemes proposed in the present disclosure to achieve non-coherent noise reduction. For simplicity, although there may be more than two audio sensors on electronic device 101, the multiple audio sensors on electronic device 101 are represented by a first microphone MIC_1 and a second microphone MIC_2 in FIG. 1. Thus, description below with respect to MIC_1 and MIC_2 is also applicable to cases in which there are more than two audio sensors.

In the example shown in FIG. 1, the first microphone MIC_1 is disposed on a first location or side (e.g., top side) of electronic device 101 while the second micro phone MIC_2 is disposed on a second location or side (e.g., bottom side) of electronic device 101 different than the first location or side thereof. As the first microphone MIC_1 and the second microphone MIC_2 are disposed on different locations and/or sides of electronic device 101, the first microphone MIC_1 may experience, and hence detect or otherwise sense, noises that are different from those detected or otherwise sensed by the second microphone MIC_2. For instance, when a wind blows toward the electronic device 101 in a direction such that the first microphone MIC_1 is facing the wind, magnitude and timing of a wind noise detected/sensed by the first microphone MIC_1 would be greater and earlier than a wind noise detected/sensed by the second microphone MIC_2.

It is noteworthy that, although wind is depicted in FIG. 1 as a source of non-coherent noises, there may be other sources of non-coherent sources. For example, handling of electronic device 101 by a user (e.g., friction with the user's hand or clothing) may generate or otherwise cause non-coherent noises. The processor 103 may be configured with one or more of the designs described below to achieve non-coherent noise reduction for enhancing the audio sensing signals generated by the first microphone MIC_1 and the second microphone MIC_2. Details of the on-coherent noise reduction will be described below.

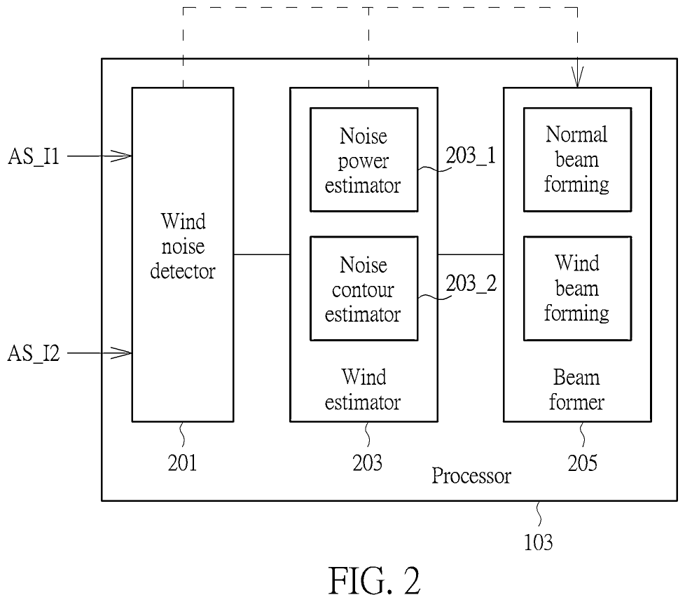

FIG. 2 is a schematic diagram illustrating a non-coherent noise reduction method according to one embodiment of the present application. Please note, in following embodiments, the wind noise detector (i.e., non-coherent noise detector) 201, the wind estimator 203 and the beam former 205 illustrated in FIG. 2 are implemented by the processor 103 in one embodiment. However, the wind noise detector 201, the wind estimator 203 and the beam former 205 may be implemented by circuits independent from the processor 103 in other embodiments. In such embodiment, the processor 103 is configured to control the operations thereof.

In the embodiment of FIG. 2, the processor 103 receives a plurality of input audio sensing signals. The input audio sensing signals correspond to a plurality of channels responsive to sensing by a plurality of microphones. For example, the processor 103 receives the input audio sensing signals AS_I1 corresponding to the first microphone MIC_1 in FIG. 1 and receives the input audio sensing signals AS_12 corresponding to the second microphone MIC_2 in FIG. 1. The first microphone MIC_1 and the second microphone MIC_2 respectively correspond to one channel. Then, the wind noise detector 201 detects whether wind noise exists in at least one of the channels. In one embodiment, the wind noise detector 201 computes the correlation levels between signals in each channel, to determine whether wind noise exists in at least one of the channels or not. The wind noise detector 201 may be implemented in a signal processing-based method or an AI-based method.

The wind estimator 203 in FIG. 2 comprises a noise power estimator 203_1 and a noise contour estimator 203_2. The noise power estimator 203_1 estimates at least one noise power of the wind noise. Please note, in one embodiment, the noise power estimator 203_1 estimates the noise power of the wind noise if the wind noise is detected by the wind noise detector 201 and does not estimate the noise power of the wind noise if the wind noise is not detected by the wind noise detector 201. However, in another embodiment, the noise power estimator 203_1 estimates the noise power of the wind noise no matter whether the wind noise is detected by the wind noise detector 201 or not. In one embodiment, the noise power is estimated by a pair of channels.

The noise contour estimator 203_2 derives at least one noise contour of the wind noise. Similarly, in one embodiment, the noise contour estimator 203_2 derives the noise contour if the wind noise is detected by the wind noise detector 201 and does not derive the noise contour if the wind noise is not detected by the wind noise detector 201. However, in another embodiment, the noise contour estimator 203_2 derives the noise contour no matter whether the wind noise is detected by the wind noise detector 201 or not. In one example, the wind d noise may exist in low-frequency bins (or named low-frequency band). Also, in one embodiment, a morphology-based method is used to derive the wind noise contour. After the noise power and the noise contour are acquired, the input audio sensing signals AS_I1, AS_I2 are enhanced according to the noise power and the noise contour if the wind noise exists in at least one of the channels. Details of enhancing the input audio sensing signals will be described in following embodiments.

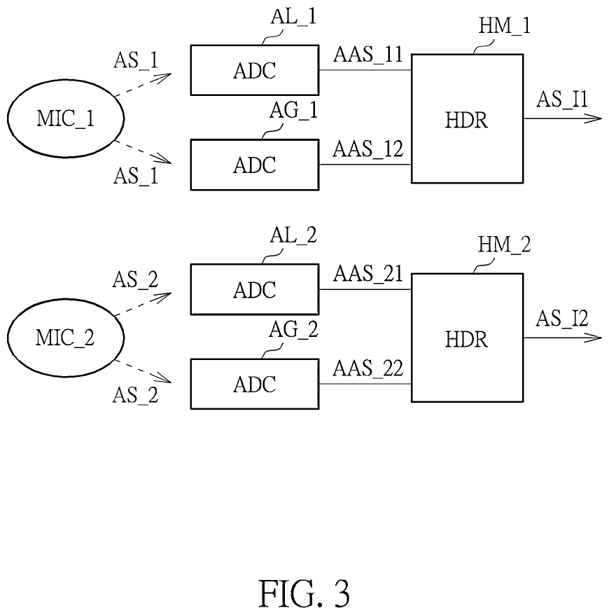

As above-mentioned, the processor 103 receives a plurality of input audio sensing signals AS_I1, AS_I2. The input audio sensing signals AS_I1, AS_I2 correspond to a plurality of channels responsive to sensing by a plurality of microphones. In one embodiment, the microphones generate audio sensing signals, and then the audio sensing signals are processed by a HDR algorithm to generate the input audio sensing signals. FIG. 3 is a schematic diagram illustrating a HDR algorithm for the audio sensing signals generated by microphones, according to one embodiment of the present application. As shown in FIG. 3, the electronic device 101 further comprises ADCs (analog to digital converter) AL_1, AG_1, AL_2, and AG_2. The ADCs AL_1, AL_2 have larger gains and the ADCs AG_1, AG_2 have smaller gains. The first microphone MIC_1 generates an audio sensing signal AS_1, and the ADCs AL_1, AG_1 respectively amplify the audio sensing signal AS_1 to generate amplified signals AAS_11, AAS_12. The amplitude of the amplified signal AAS_11 is larger than which of the amplified signal AAS_12. Similarly, the second microphone MIC_2 generate an audio sensing signals AS_2, and the ADCs AL_2, AG_2 respectively amplify the audio sensing signal AS_2 to generate amplified signals AAS_21, AAS_22. The amplitude of the amplified signal AAS_21 is larger than which of the amplified signal AAS_22.

In the embodiment of FIG. 3, the electronic device 101 further comprises HDR (High Dynamic Range) modules HM_1, HM_2. The HDR modules HM_1, HM_2 may be implemented by executing programs via the processor 103 or circuit independent from the processor 103. The HDR modules HM_1, HM_2 respectively and selectively mix the amplified signals AAS_11, AAS_12 and the amplified signals AAS_21, AAS_22 as the input audio sensing signals AS_I1 and AS_I2 show in FIG. 2. In one embodiment, the HDR modules HM_1, HM_2 selectively mix the amplified signals according to the amplitudes of the audio sensing signals. For example, if the audio sensing signal AS_1 has a large amplitude, the HDR module HM_1 gives the amplified signal AAS_12 (smaller gain) a larger weight and gives the amplified signal AAS_11 (larger gain) a smaller weight. On the contrary, if the audio sensing signal AS_1 has a small amplitude, the HDR module HM_1 gives the amplified signal AAS_12 a smaller weight and gives the amplified signal AAS_11 a larger weight. The HDR module HM_2 may operate in the same manner of the HDR module HM_1.

The operations stated in FIG. 3 may be summarized as: amplifying the audio sensing signals by different gains to generate amplified signals; providing different weights to the amplified signals to generate the input audio sensing signals, according to the amplitudes of the audio sensing signals. It will be appreciated that such summarized step may be implemented by other methods rather than the HDR algorithm stated in FIG. 3.

The embodiment illustrated in FIG. 3 may be used for adapting different scenarios such as the scenario with wind noise and the scenario with small volume sound. For instance, wind noise can easily cause the audio sensing signal to be clipping, where the maximum value of the amplitude exceeds a limit and causes the undesired distortion. With the usage of small gain ADC, it can prevent the input audio sensing signal from exceeding the limit. In contrast, to sense the sound with small volume, a larger gain ADC is required, otherwise the sound would be easily mixed with the undesired noise. Therefore, in order to dynamically handle different scenarios, the embodiment of FIG. 3 may be used to adjust the mixing weight between the signals from the ADCs with different gain values.

Please refer to FIG. 2 again, as above-mentioned, the input audio sensing signals AS_I1, AS_I2 are enhanced according to the noise power and the noise contour if the wind noise exists in at least one of the channels. In one embodiment, the enhancement comprising selectively performs different beam forming according to if the wind noise exists. As shown in FIG. 2, the electronic device 101 further comprises a beam forming module 205, which may be implemented by executing programs via the processor 103 or circuit independent from the processor 103. The beam forming module 205 may perform normal beam forming or wind beam forming. If the wind noise does not exist, the normal beam forming is performed. Oppositely, if the wind noise exists, the wind beam forming is performed.

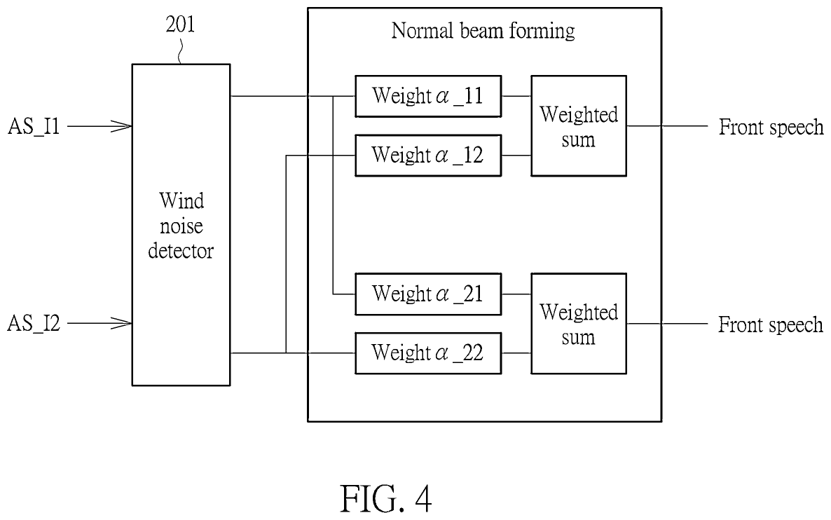

FIG. 4 is a schematic diagram illustrating the normal beam forming illustrated in FIG. 2, according to one embodiment of the present application. In the embodiment of FIG. 4, the normal beam forming provides different weights such as weights α_11, α_12, α_21 and α_22. The normal beam forming computes the mixing weight for each channels. With the normal beam forming, the target sound on the target direction may be enhanced. For example, in one embodiment, the front speech is enhanced. Please note, the normal beam forming may be implemented by other steps rather than the steps illustrated in FIG. 4.

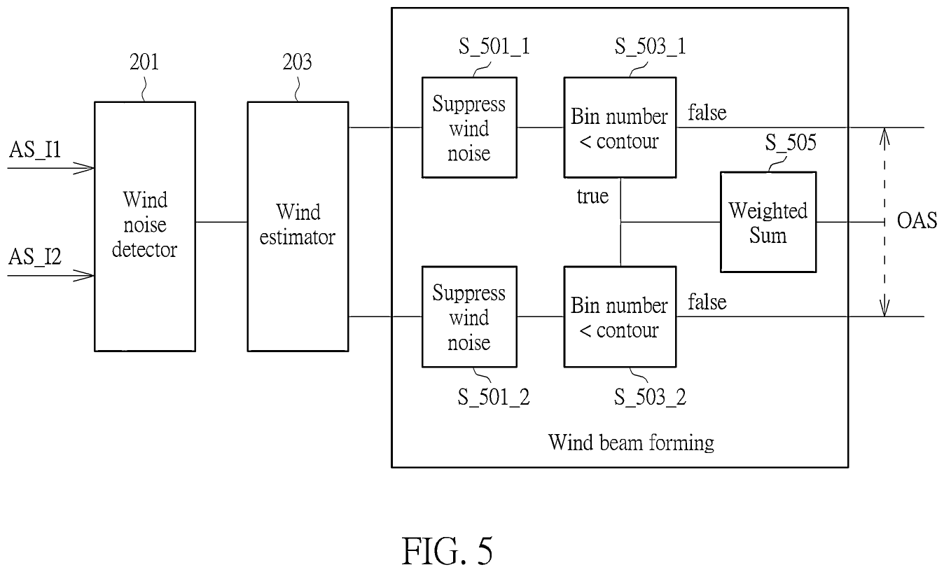

FIG. 5 is a schematic diagram illustrating the wind beam forming illustrated in FIG. 2, according to one embodiment of the present application. In the embodiment of FIG. 5, the wind noise is suppressed by the steps S_501_1, S_501_2 first, before entering the steps S_505. Further, the steps S_503_1, S_503_2 and S_505 may be performed without the steps S_505. The steps S_503_1, S_503_2 determine whether the bins are covered by the noise contour or not. For the convenience of explaining, in following descriptions, the bins which are covered by the noise contour are named as first bins, and the bins which are not covered by the noise contour are named as second bins. If the bins are first bins, the steps S_505 is performed. If the bins are not first bins, the bins are not processed by the step S_505.

In the step S_505, a first weight is provided to first signals in first bins of the audio sensing signals and a second weight is provided to second signals in first bins of the audio sensing signals, the second weight is larger than the first weight, when the noise power of the first signals is larger than the noise power of the second signals. In one embodiment, the first signals and the second signals respectively are from different channels. For example, the first signals and the second signals are respectively at least portions of the audio sensing signal AS_1 and the audio sensing signal AS_2.

In one embodiment, in the steps S_503_1 and S_503_2, if the bin number is smaller than the noise contour, the bins are the first bins covered by the noise contour since the wind noise is in a lower-frequency bin. In such case, the signals which are covered by the noise contour and have a larger noise power are provided a smaller weight in the step S_505. On the contrary, the signals which are covered by the noise contour and have a smaller noise power are provided a larger weight in the step S_505. After that, the signals in all bins are mixed to generate the output audio sensing signals OAS, which is the audio signal that the user hears. In some embodiments, the signals in the second bin from different channels are kept original. For example, the signals in the second bin are provided with the maximum weight. The output audio sensing signals OAS can therefore still represent the characteristics in the second bins of different channels after mixing signals in all bins. By using the wind beam forming, the signals are mixed at a bin level, such that the bins which are more severely damaged by the wind (i.e., with a larger noise power) would be dominated by the bins which are less severely damaged by the wind noise (i.e., with a smaller noise power). In one embodiment, the switch between the normal beam forming and the wind beam forming may be smoothened by an alpha filter. In such case, no hard switch is provided between the normal beam forming and the wind beam forming to avoid the unnatural distortion on signals.

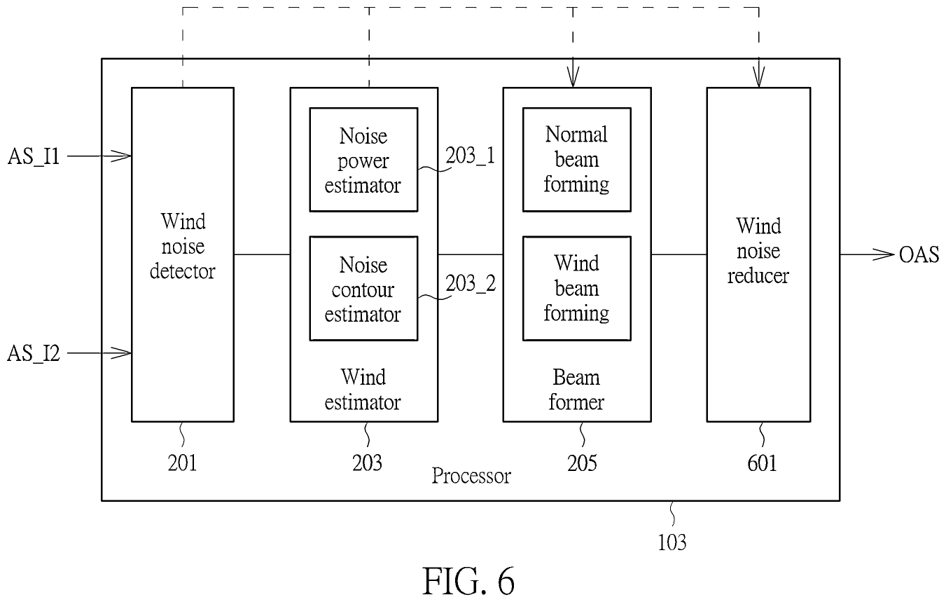

Besides the modules illustrated in FIG. 2, the non-coherent noise reduction method provided by the present application may comprise other modules. FIG. 6 is a schematic diagram illustrating a non-coherent noise reduction method according to another embodiment of the present application. In the embodiment of FIG. 6, besides the wind noise detector 201, the wind estimator 203 and the beam former 205, a wind noise reducer (i.e., a non-coherent noise reducer) 601 is further provided. The wind noise reducer 601 may be implemented by executing programs by the processor 103 or by circuits independent from the processor 103. The wind noise reducer 601 may generate a suppression mask on the time-frequency domain. The suppression mask may contain suppression levels (or suppression values) for each bin. Also, the wind noise reducer 601 may be trained by a deep learning model such as CNN base or U Net, or machine learning.

The wind noise reducer 601 may perform wind noise reduction according to the detection result of the wind noise detector 201. In one embodiment, if the wind noise exists, the wind noise detector 201 performs a wind noise reduction to suppress the wind noise in first bins for a first suppress level, and performs the wind noise reduction to suppress the wind noise in second bins for a second suppress level by the wind noise reducer. The first bins are covered by the noise contour, and the second bins are not covered by the noise contour. The first suppress level is higher than the second suppress level. Briefly, the wind noise reducer 601 suppresses the signals the bins more if the bins are covered by the noise contour. In such embodiment, the suppress level may be modified by modifying the suppression mask by bounding the maximum suppression value. In another embodiment, the wind noise reducer 601 performs the wind noise reduction to suppress the wind noise in all bins for an identical level, if the wind noise is not detected in the channels. The switch between these two modes may be smoothened by an alpha filter on the suppression mask, and the unnatural distortion on signals could be also eliminated.

In one embodiment, if the normal beam forming is used, such as the embodiment in FIG. 4, the wind noise reducer 601 is by passed thus no wind noise reduction is performed. Besides, if the wind beam forming is used, such as the embodiment illustrated in FIG. 5, the steps S_501_1 and S_501_2 in FIG. 5 may be performed by the wind noise reducer 601. In such case, the sequence of the beam former 205 and the wind noise reducer 601 may be swapped. Further, in such case, the normal beam forming may be by passed to prevent the wind noise from spreading across different channels.

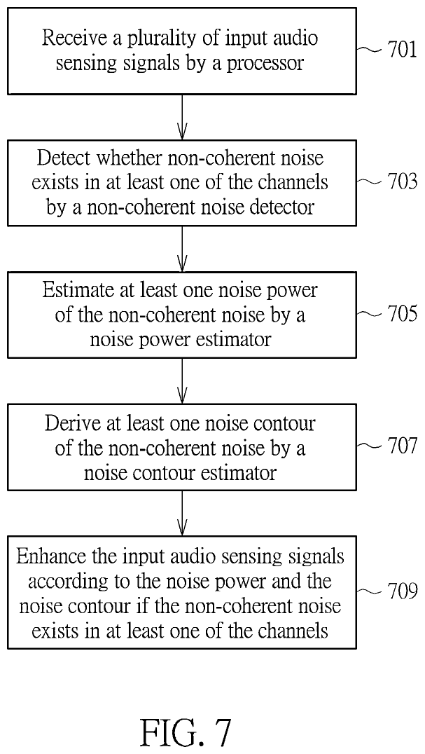

The above-mentioned embodiments may be summarized as the non-coherent noise reduction method illustrated in FIG. 7. The steps in FIG. 7 comprise:

### Step 701

Receive a plurality of input audio sensing signals by a processor (e.g., the processor 103 in FIG. 1), wherein the input audio sensing signals correspond to a plurality of channels responsive to sensing by a plurality of audio sensors.

### Step 703

Detect whether non-coherent noise exists in at least one of the channels by a non-coherent noise detector (e.g., the wind noise detector 201 in FIG. 2).

### Step 705

Estimate at least one noise power of the non-coherent noise by a noise power estimator (e.g., by the wind estimator 203 in FIG. 2), if the non-coherent noise exists in at least one of the channels.

### Step 707

Derive at least one noise contour of the non-coherent noise by a noise contour estimator (e.g., by the wind estimator 203 in FIG. 2), if the non-coherent noise exists in at least one of the channels.

### Step 709

Enhance the input audio sensing signals according to the noise power and the noise contour if the non-coherent noise exists in at least one of the channels.

The enhancement may comprise using the beam former 205 in FIG. 2 or the wind noise reducer 601 in FIG. 6, as above-mentioned descriptions. Other detail steps may be acquired in view of above-mentioned embodiments, thus descriptions thereof are omitted for brevity here.

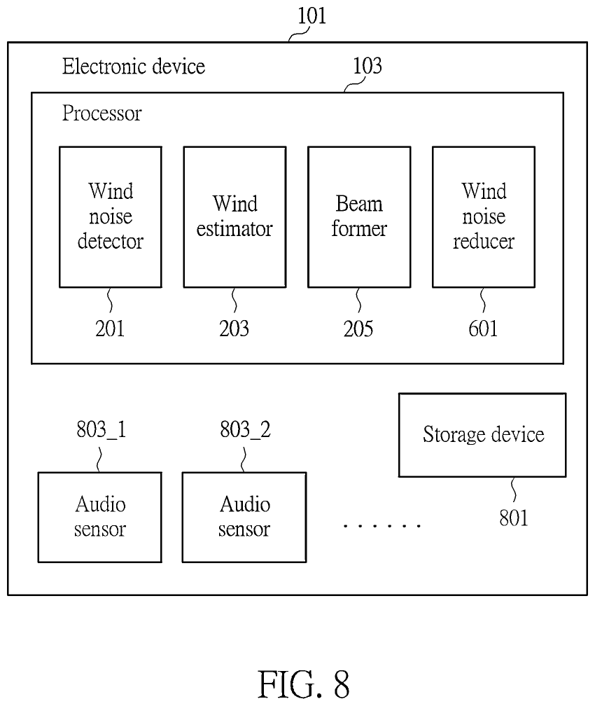

The above-mentioned non-coherent noise reduction method may be applied to various electronic devices, such as the electronic device 101 illustrated in FIG. 1. FIG. 8 is a block diagram illustrating an exemplary electronic device applying the non-coherent noise reduction method provided by the present application. As shown in FIG. 8, the electronic device 101 comprises the processor 103, a storage device 801 and a plurality of audio sensors 803_1, 803_2 . . . (only two of the audio sensors are illustrated). The processor 103 may execute programs recorded in the storage device 801 to achieve above-mentioned embodiments. However, the processor 103 may execute programs from any other resource to achieve above-mentioned embodiments.

The audio sensors 803_1, 803_2 are configured to sense a plurality of audio sensing signals, such as the audio sensing signals AS_1, AS_2 illustrated in FIG. 3. The processor 103 is configured to perform following steps: (a) receiving a plurality of input audio sensing signals (e.g., the input audio sensing signals AS_I1, AS_I2 in FIG. 2) generated according to the audio sensing signals, wherein the input audio sensing signals correspond to a plurality of channels responsive to sensing by the audio sensors 803_1, 803_2; (b) controlling a wind noise detector 201 to detect whether wind noise exists in at least one of the channels; (c) controlling a noise power estimator in the wind estimator 203 to estimate at least one noise power of the wind noise, if the non-coherent noise exists in at least one of the channels; (d) controlling a noise contour estimator in the wind estimator 203 to derive at least one noise contour of the wind noise, if the non-coherent noise exists in at least one of the channels; and (e) enhancing the input audio sensing signals according to the noise power and the noise contour if the non-coherent noise exists in at least one of the channels.

As above-mentioned, the enhancement may be performed by the beam former 205 or the wind noise reducer 601. Also, as above-mentioned, the wind noise detector 201, the wind estimator 203, the beam former 205 and the wind noise reducer 601 may be implemented by executing programs by the processor 103, such as the example illustrated in FIG. 8, or be implemented by circuits different from the processor 103.

In view of above-mentioned embodiments, the wind power in each bin, each channel may be estimated. Also, the signals with dynamic ranges of bin and weight are mixed such that stereo output or even multi-channel output may be provided. Further, suppression levels of the wind noise reducer may be dynamically adjusted. Additionally, the beam forming strategies without wind noise reduction and with wind noise reduction may be switched.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A non-coherent noise reduction method, comprising:
(a) receiving a plurality of input audio sensing signals by a processor, wherein the input audio sensing signals correspond to a plurality of channels responsive to sensing by a plurality of audio sensors;
(b) detecting whether non-coherent noise exists in at least one of the channels by a non-coherent noise detector;
(c) estimating at least one noise power of the non-coherent noise by a noise power estimator, if the non-coherent noise exists in at least one of the channels;
(d) deriving at least one noise contour of the non-coherent noise by a noise contour estimator, if the non-coherent noise exists in at least one of the channels; and
(e) enhancing the input audio sensing signals according to the noise power and the noise contour if the non-coherent noise exists in at least one of the channels.

2. The non-coherent noise reduction method of claim 1, further comprising:
performing beam forming to the input audio sensing signals if the non-coherent noise is not detected in at least one of the channels.

3. The non-coherent noise reduction method of claim 2, wherein the step (e) comprises:
if the non-coherent noise is detected in at least one of the channels,
providing a first weight to first signals in first bins of the audio sensing signals, wherein the first bins are covered by the noise contour; and
providing a second weight to second signals in the first bins of the audio sensing signals, wherein the noise power of the first signals is larger than the noise power of the second signals, wherein the second weight is larger than the first weight.

4. The non-coherent noise reduction method of claim 3, further comprising:
suppressing the non-coherent noise, before providing the first weight to the signals in the first bins and before providing the second weight to the signals in the second bins.

5. The non-coherent noise reduction method of claim 1, wherein the step (e) comprises:
performing a non-coherent noise reduction to suppress the non-coherent noise in first bins for a first suppress level, wherein the first bins are covered by the noise contour; and
performing the non-coherent noise reduction to suppress the non-coherent noise in second bins for a second suppress level by the non-coherent noise reducer, wherein the second bins are not covered by the noise contour, wherein the first suppress level is higher than the second suppress level.

6. The non-coherent noise reduction method of claim 5, further comprising:
performing the non-coherent noise reduction to suppress the non-coherent noise in all bins for an identical level, if the non-coherent noise does not exists in the channels.

7. The non-coherent noise reduction method of claim 5,
wherein the performing of the non-coherent noise reduction comprises performing the non-coherent noise reduction by using a deep learning model or machine learning.

8. The non-coherent noise reduction method of claim 1, wherein the audio sensors are configured to generate audio sensing signals, wherein the non-coherent noise reduction method further comprises:
amplifying the audio sensing signals by different gains to generate amplified signals;
providing different weights to the amplified signals to generate the input audio sensing signals, according to the amplitudes of the audio sensing signals.

9. The non-coherent noise reduction method of claim 1, wherein the audio sensors are microphones and the non-coherent noise is wind noise.

10. The non-coherent noise reduction method of claim 9, wherein the microphones are disposed at different locations at an electronic device.

11. An electronic device, comprising:
a plurality of audio sensors, configured to sensing a plurality of audio sensing signals;
a processor, configured to perform following steps:
(a) receiving a plurality of input audio sensing signals generated according to the audio sensing signals, wherein the input audio sensing signals correspond to a plurality of channels responsive to sensing by the audio sensors;
(b) controlling a non-coherent noise detector to detect whether non-coherent noise exists in at least one of the channels;
(c) controlling a noise power estimator to estimate at least one noise power of the non-coherent noise, if the non-coherent noise exists in at least one of the channels;
(d) controlling a noise contour estimator to derive at least one noise contour of the non-coherent noise, if the non-coherent noise exists in at least one of the channels; and
(e) enhancing the input audio sensing signals according to the noise power and the noise contour if the non-coherent noise exists in at least one of the channels.

12. The electronic device of claim 11, wherein the processor is further configured to perform:
controlling a beam former to perform beam forming to the input audio sensing signals if the non-coherent noise is not detected in at least one of the channels.

13. The electronic device of claim 12, wherein the step (e) comprises:
providing a first weight to first signals in first bins of the audio sensing signals, wherein the first bins are covered by the noise contour; and
providing a second weight to second signals in the first bins of the audio sensing signals, wherein the noise power of the first signals is larger than the noise power of the second signals, wherein the second weight is larger than the first weight.

14. The electronic device of claim 13, wherein the processor is further configured to perform:
controlling suppressing of the non-coherent noise, before providing the first weight to the signals in the first bins and before providing the second weight to the signals in the second bins.

15. The electronic device of claim 11, wherein the step (e) comprises:
performing a non-coherent noise reduction to suppress the non-coherent noise in first bins for a first suppress level, wherein the first bins are covered by the noise contour; and
performing the non-coherent noise reduction to suppress the non-coherent noise in second bins for a second suppress level by the non-coherent noise reducer, wherein the second bins are not covered by the noise contour, wherein the first suppress level is higher than the second suppress level.

16. The electronic device of claim 15, wherein the processor is further configured to perform:
controlling a non-coherent noise reducer performing the non-coherent noise reduction to suppress the non-coherent noise in all bins for an identical level, if the non-coherent noise does not exists in the channels.

17. The electronic device of claim 15,
wherein the non-coherent noise reducer performs the non-coherent noise reduction by using a deep learning model or machine learning.

18. The electronic device of claim 11, wherein the audio sensors are configured to generate audio sensing signals, wherein the processor is further configured to perform:
controlling ADCs to amplify the audio sensing signals by different gains to generate amplified signals;
controlling HDR (high dynamic range) modules to provide different weights to the amplified signals to generate the input audio sensing signals, according to the amplitudes of the audio sensing signals.

19. The electronic device of claim 11, wherein the audio sensors are microphones and the non-coherent noise is wind noise.

20. The electronic device of claim 19, wherein the microphones are disposed at different locations of the electronic device.
